(19) United States
(12) Patent Application Publication
(10) Pub. No.: US 2011/0082247 A1
(43) Pub. Date: Apr. 7, 2011

(54) VISCOSITY MODIFIED ALCOHOLS

(75) Inventor: Ashoke K. SenGupta, Barrington, IL (US)

(73) Assignee: AMCOL INTERNATIONAL CORP.

(21) Appl. No.: 12/574,546

(22) Filed: Oct. 6, 2009

(51) Int. Cl. C08G 18/48; C08K 5/05

(52) U.S. Cl. 524/386; 528/76

(57) ABSTRACT

Described herein, in the preferred embodiment, is a polyurethane resin binder. The binders described herein comprise a polymerizable polyol, an isocyanate, and a polymerization catalyst to make a polyurethane resin binder.

### CROSS-REFERENCE TO RELATED APPLICATIONS

This application is related to and filed concurrent with copending U.S. patent application Ser. No. 12/574,475, 12/574,501 and 12/574,525.

### TECHNICAL FIELD

This invention relates to viscosity modification, polyurethane formulations, and a processes for making soft-composite polyurethanes. Specifically, this invention relates to thickened alcohol compositions for use in polyurethane formulations and the tailoring of polyurethane characteristics by augmentation of the polyol composition.

### BACKGROUND AND PRIOR ART

Polyurethanes blended with other polymers and polyurethane components polymerized in the presence of other polymers and small molecules are known in the art. Examples include the following patents and patent applications:

U.S. Pat. No. 4,302,553 discloses a number of blended polymer materials. The materials consist of combinations of polyurethanes with polyacrylates, polyepoxides, polyesters, styrene-butadiene polymers, and polydimethyl siloxanes.

U.S. Pat. No. 4,923,934 discloses a interpenetrating polymer network for coating applications. The material consists of a polyurethane and an epoxy resin.

U.S. Pat. No. 5,328,957 discloses interpenetrating polymer networks to be used for acoustic dampening. The material consists of chemically dissimilar cross-linked polymer chains that have substantially no chemical binding between them. Specifically, a polyurethane and a polyacrylate.

U.S. patent application Ser. No. 10/735,310 discloses a polyurethane gel formulation containing transdermal therapeutic materials. The gel formulations include penetration enhancers including decyl oleate, isopropyl myristate, isopropyl palmitate, 2-octyldodecanol, fatty acids and fatty acid methyl esters.

EP 184993A1 discloses a polyurethane polyethylene thermoplastic film that is water-vapor permeable. The film is manufactured by blowing a coextruded blend of the polymers, optionally including anti-blocking agents and anti-slip agents, e.g., silica, silicates, carbonates, clay, silicone spheres, PMMA spheres, silicones, and fatty amides.

The art neither teaches the incorporation of a polyether diester in polyurethanes nor teaches the modification of the viscosity of urethane polymerizable polyols. Herein is disclosed a beneficial method for modifying the viscosity of the polyol as well as affecting the physical properties of a resultant polyurethane.

### SUMMARY

Described herein, in the preferred embodiment, is a viscosity modified polyol for use in reacting with an isocyanate or poyisocyanate to form a polyurethane resin. The viscosity modified polyol is a polymerizable polyol preferably thickened with a structurally similar polyether diester thickening agent. In one embodiment, the polyol is admixed with a polyether diester and the resultant thickened polyol has a shear-thinning rheology. In another embodiment, the thickened polyol is admixed with a polymerizable isocyanate and a polyurethane polymerization catalyst to form a polyether diester/polyurethane composite. In yet another embodiment, soft polyurethane composites are made from traditional polyurethane precursors.

### DETAILED DESCRIPTION

In a preferred embodiment an alcohol is admixed with a thickening agent to form a viscosity modified alcohol. Preferably, the viscosity of the alcohol is increased to a viscosity where the alcohol does not freely flow. While the viscosity of the alcohol is dependant on the chemical structure and the incorporation of other solvents into the alcohol, the viscosity of the thickened alcohol is preferably greater than about 1,000 cps, more preferably greater than about 5,000 cps, even more preferably greater than about 10,000 cps, and still more preferably greater than about 50,000 cps (as measured using a Brookfield viscometer at a spindle speed of 0.5 rpm). Moreover, the thickened alcohol preferably has a shear-thinning rheology. As used herein, shear thinning means the viscosity of the thickened alcohol decreases when the thickened alcohol is subjected to increasing shear force. The effect of shear thinning can be observed by measuring the viscosity at various shear rates. The specific viscosity of individual thickened alcohol samples are dependant on numerous factors, including the concentration of the components, the thickening agent, and the chemical structure of the alcohol. Preferably, the viscosity of the thickened alcohol decreases by at least 50% when the shear rate is increased from about 5 rpm to about 100 rpm, as measured with a Brookfield Viscometer.

In one embodiment, the alcohol is a primary, secondary, tertiary, or aromatic alcohol. Preferably the alcohol is a primary or secondary alcohol, more preferably the alcohol is comprises only one alcohol functionality, even more preferably the alcohol is selected from the group of methanol, ethanol, propanol, 2-propanol, n-butanol, 2-butanol, isobutanol, and mixtures thereof.

In another embodiment, the alcohol is a polyol. Preferably, the polyol is applicable in urethane polymerization. Still further, the thickened polyol (alcohol) preferably has good performance in urethane polymerization, leading to good binder properties. Suitable polymerizable polyols include, but are not limited to glycols, glycerols, aryl and/or alkyl diols, and mixtures thereof. Glycols include those linear glycols (alkyl diols) that have a molecular formula of HO—(CH₂CH₂O)ₓ—H, where x is a value between 1 and about 25; and the branched polyols that have a molecular formula of HO—(CH₂CH₂(R)O)ₓ—H, where x is a value between 1 and about 25, and R is a linear, branched, cyclic, alkyl, and/or aromatic group that optionally includes one or more pnictide, chacogenide, and/or halide-containing functionalities. One preferred class of the branched polyols are the glycerols, wherein at least one R contains an alcohol functionality. A second preferred class of the branched polyols are acyclic ethylene glycols, non-limiting examples include dipropylene glycol, tripropylene glycol, and the like. Suitable polyols additionally include mixed glycols and mixed glycerols. An illustrative example of a mixed glycol is a hydroxy-ethyleneglycol-p-xylene (HOCH₂C₆H₄CH₂OCH₂CH₂OH). Preferably, the polymerizable polyol is a linear glycol having a molecular formula wherein x is a value between 1 and about 10, more preferably wherein x is between 1 and about 5, and even more preferably 3, wherein the glycol is triethylene glycol.

Preferably, the thickening agent is an urethane compatible polymer, more preferably the thickening agent does not prevent the urethane polymerization reaction. Suitable thickening agents include homopolymers and copolymers selected from the group consisting of polyethylene glycol/poly(oxyethylene) (PEG), polypropylene glycol, poly(acrylic acid) (PAA), poly(methacrylic acid) (PMA), poly(vinyl alcohol) (PVA), poly(acrylamide), poly(ethylene imine), poly(diallyldimethyl ammonium halide), poly(vinyl methyl ether), gelatins, and polysaccharides. More preferably, the thickening agent has a chemical structure that is compatible with and/or structurally similar (chemically and/or electronically) to that of the polyol. The weight average molecular weight of the thickening agent can be up to about 5,000,000 Dalton. Preferably, the thickening agent is a diesterified polyether, more preferably (particularly when the polyol is a glycol) the thickening agent is a diesterified homo- or co-polymer of polyethylene glycol (PEG). Preferably, the weight average molecular weight of the PEG-based thickening agent is in the range of about 1,000 to about 60,000 Dalton, more preferably about 2,000 to about 30,000 Dalton, and most preferably about 4,000 to about 10,000 Dalton. One of ordinary skill in the art will recognize that the thickening agent's compatibility with and/or structural similarity to the polyol depends on the chemical structure of the polyol, while illustrated above is the compatibility and structural similarity of a PEG diester and a glycol, e.g., triethylene glycol, the paring can be between a variety of different thickening agents and polyols.

Commercial PEG polymers are generally labeled as either PEG-n or PEG M, where (n) refers to the average number of ether oxygen groups or the ethylene oxide (EO) repeat units, and the letter (M) refers to an average molecular weight of the polymer. For example, a PEG with n=150 would have an average molecular weight of about 6,000 Dalton and would be labeled as either PEG-150 or PEG 6000. For consistency herein, the PEG polymers are referred to by the average number of EO repeat units per polymer chain and one of ordinary skill in the art can convert one denotation to another.

Herein, the preferred PEGs are those PEGs in the range of PEG-25 to PEG-1400, more preferably in the range of PEG-45 to PEG-700, even more preferably in the range of PEG-90 to PEG-225, and still more preferably PEG-100, PEG-125, and PEG-150. Herein, the preferred thickening agents are diesterified where the ester functionality has a linear, branched, cyclic and/or aromatic group. Preferably, the ester functionality is a linear or branched alkyl group, more preferably the alkyl chain length is equal to or greater than about 8 (C₈). More preferably the alkyl chain length is about C₈-C₁₈, still more preferably the alkyl chain is stearate. Non-limiting examples of thickening agents that correspond to the above recited preferences are PEG-100 distrearate, PEG-125 distrearate, and PEG-150 distrearate. Other preferably thickening-agents include glyceryl esters, having a weight average molecular weight in the range of about 1,000 to about 15,000 Dalton, more preferably about 2,000 to about 10,000 Dalton, and most preferably about 4,000 to about 7,000 Dalton.

Preferably, the thickening agent is incorporated into the thickened polyol suspension in a concentration of about 0.05 to about 30 wt. %, more preferably about 0.1 to about 20 wt. %, even more preferably about 0.5 to about 5 wt. %, based on the weight of the polyol.

One general means for preparing a thickened polyol involves the hot processing of the polyol and the thickening agent. For example, a mixture of the polyol and the thickening agent can be heated to above a melting point of one or both components and then cooled to about 23° C. while under agitation. Alternatively, a solid component (often the thickening agent) can be heated to a temperature above its melting point and then added to a liquid component while under agitation. One preferable means for agitating the mixture is a Caframo-type mixer fitted with a paddle agitator operating at about 1,500 rpm.

In a preferred embodiment, a thickened polyol, a polymerizable isocyanate, and a polyurethane polymerization catalyst are provided as a multi-component kit for admixing to form a polyurethane resin. The admixing of the kit components can be either stepwise or some of the kit components, e.g., the isocyanate component and the catalyst component can be admixed prior to admixing with the thickened polyol. Preferably, the thickened polyol imparts at least some flow resistance to a polyol-isocyanate mixture, more preferably the polyol-isocyanate mixture prior to polyurethane formation has a shear-thinning rheology. Another aspect of the multi-component kit described herein is to provide polyurethane resins utilizing the resin components.

Another important aspect of the multi-component kit is the stability of the kit over time. The separation of the thickened polyol after preparation would be detrimental to the transport, storage, and utility of the suspension. Herein, the described thickened polyol are stable over a sufficient time to allow remote manufacturing, and subsequent transport, storage, and use without reagitation.

The isocyanate component is preferably a polyisocyanate, for example a diisocyanate, a triisocyanate, and so on. The isocyanate component can be either a small molecule isocyanate, a polymeric isocyanate, or a blend of a plurality of isocyanates. Suitable isocyanates include p-phenylene diisocyanate (CAS No. 104-49-4), toluene diisocyanate (CAS No. 1321-38-6), 4,4′-methylenebis(phenylisocyanate) (CAS No. 101-68-8), polymethylene polyphenyl isocyanate (CAS No. 9016-87-9), 1,5-naphthalene diisocyanate (CAS No. 3173-72-6), bitolylene diisocyanate (CAS No. 91-97-4), m-xylene diisocyanate (CAS No. 3634-83-1), m-tetramethylxylene diisocyanate (CAS No. 58067-42-8), hexamethylene diisocyanate, (CAS No. 4098-71-9), 1,6-diisocyanato-2,2,4,4-tetramethylhexane (CAS No. 83748-30-5), 1,6-diisocyanato-2,4,4-trimethylhexane (CAS No. 15646-96-5), trans-cyclohexane-1,4-diisocyanate (CAS No. 2556-36-7), 1,3-bis(isocyanatomethyl)cyclohexane (CAS No. 38661-72-2), 3-isocyanato-methyl-3,5,5-trimethylcyclohexyl isocyanate (CAS No. 4098-71-9), dicyclohexylmethane diisocyanate (CAS No. 5124-30-1) and the polymeric 4,4′-methylene bis(phenylisocyanates) available under the MONDUR product line from BAYER MATERIALSCIENCE. Preferably, the isocyanate component is the “Mondur MR” product available from BAYER MATERIALSCIENCE.

Catalyst components for facilitating the polyol-isocyanate reaction include tin and alkaline catalysts. Alkaline catalysts include aliphatic and aromatic amines and/or primary, secondary and tertiary amines. A non-limiting list of applicable catalysts include 1,4-diazabicyclo[2.2.2]octane (DABCO), 1,5-diazabicyclo[4.3.0]non-5-ene (DBN), 1,8-diazabicyclo[5.4.0]undec-7-ene (DBU), pentamethyldipropylenetriamine, bis(dimethylamino ethyl)ether, pentamethyldiethylenetriamine, dimethylcyclohexylamine, tris(3-dimethylamino) propylamine, and other liquid tertiary amines. One preferably catalyst component is tris(3-dimethylamino) propylamine.

Preferably, the composition of the thickened polyol affects the physical characteristics of the resultant polyurethane. More preferably, the use of the thickened polyol yields a polyurethane that has enhanced water permeability. One beneficial aspect of enhanced water permeability in the herein described polyurethanes is improved osmotic barrier properties. Preferably, osmotic barrier properties enhance membrane applications, specifically water desalination. One of ordinary skill in the art of reverse osmotic water purification would comprehend how to employ films or layers of the herein described polyurethanes for water purification and/or water desalination.

Another aspect of the herein described polyurethanes are polyurethane sheets, layers, and/or coating that have enhanced antistatic properties. One means for dissipating static electrical charges on objects is to coat or cover them with a layer of material that weakly conducts electricity. Preferably the layer dissipates charge build up by conducting static charge from one area of the object to the area of the object with the opposite charge.

Still another aspect of the herein described polyurethanes is the further incorporation of polyether diester compatible fillers. Examples of applicable fillers include pigments, colorants, flame retardants, electrically conductive fillers, electrically insulative fillers, thermally conductive fillers, thermally insulative fillers, antioxidants, light stabilizers, metallic fillers including active catalysts, and structural composite fillers. The addition of fillers takes at least two distinct paths, those fillers that do not interact with the herein described polyurethane resin and those that physically or chemically bind/react with the polyurethane resin. Non-limiting examples include fiberglass fillers that do not interact with the herein described polyurethane resin and active metal precatalysts that bind to the polyether functionality in either or both the polyether diester or the polyurethane backbone. One of ordinary skill in the art of polymer formulation will understand how to both include fillers in the herein described polyurethane and adjust the physical properties of the polyurethane in light of the addition of the applicable filler.

Yet another aspect of the herein described thickened alcohols is the use of the thickened alcohols in topical formulations. Examples include the application of thickened alcohols, e.g., including ethanol, as a disinfectant and/or antiseptic. Another example includes the application of thickened alcohols as a humectant, an emollient, and/or a lubricant. Yet another example is the inclusion of a thickened alcohol in a topical formulation that includes other disinfectants, antiseptics, humectants, emollients, lubricants, fragrances, surfactants, solvents, vitamins, and/or other compositions known in topical formulations.

The compositions and processes described herein have been primarily described and illustrated in terms of their use in the foundry art, but those skilled in the art will recognize that the binder resins and binder resin-containing compositions described herein may also be utilized in other fields, including adhesives, coatings, and composites.

What is claimed is:

1. A thickened alcohol composition comprising:
an alcohol, and a polyether diester thickening agent for the alcohol.

2. The composition of claim 1, wherein the alcohol is a polymerizable polyol.

3. The composition of claim 1 comprising about 0.05 to about 30 wt. % of the thickening agent, based on the weight of the alcohol.

4. The composition of claim 3, wherein the composition has a viscosity greater than about 1,000 cps.

5. A polyurethane kit comprising:
a thickened polyol, a polymerizable isocyanate, and a catalyst; wherein the thickened polyol comprises a polymerizable polyol and a thickening agent and has a viscosity greater than about 1,000 cps.

6. A material comprising:
a polyurethane; wherein the polyurethane was made by the polymerization of a thickened polyol and a polymerizable isocyanate; and wherein the thickened polyol comprised a polymerizable polyol and a polyether diester, and had a viscosity greater than about 1,000 cps.
